(19) United States
(12) Patent Application Publication
(10) Pub. No.: US 2017/0203232 A1
(43) Pub. Date: Jul. 20, 2017

(54) Low Energy Process for purifying water and reducing crop water consumption

(71) Applicants: Duncan Charles Hare, Santa Ana, CA (US); David Hobbs, New Westminster (CA)

(72) Inventors: Duncan Charles Hare, Santa Ana, CA (US); David Hobbs, New Westminster (CA)

(21) Appl. No.: 15/289,960

(22) Filed: Oct. 10, 2016

Related U.S. Application Data
(60) Provisional application No. 62/279,803, filed on Jan. 17, 2016.

(51) Int. Cl. B01D 5/00; A01G 9/24; C02F 1/14; B01D 1/00; C02F 1/04

(52) U.S. Cl. CPC B01D 5/006; B01D 1/0035; C02F 1/048; C02F 1/14; A01G 9/247; C02F 2103/365

(57) ABSTRACT

The low-energy water reclamation process consists of evaporation from water sources, followed by capturing, condensing and reusing the water released into the atmosphere from both the evaporation process and by plant transpiration. 95% to 99% of water from plant transpiration is lost by venting to the atmosphere. We capture that water, and reuse it, to grow food or provide potable water. Reclaiming and reusing the evaporated water reduces both the amount of new water required for plant growth or potable water production, and also reduces the total energy requirement for the process. Over a large growing area, we expect to reclaim a significant amount of transpired water, which will reduce the need for new water to grow food and/or provide pure unpolluted potable water, at lower total cost.

### TECHNICAL FIELD OF THE INVENTION

The present invention relates in General to Water production and Use in Horticulture and Agriculture, and more particularly to apparatus and methods for purifying, reducing and recycling the quantity of water for both human consumption and water for growing crops.

### BACKGROUND OF THE INVENTION

Due to Climate Change, the ever-increasing number of people on the planet, and the mining of sub-surface water reservoirs, the world is facing a shortage of water suitable for drinking and growing food (crops).

For example, The Southwestern region of the US, including the Colorado River basin, is facing a decrease in rainfall, and an increase in population, which places further demand on the need for water.

In addition, mining processes such as fracking consume large quantities of water, much of which is polluted by the fracking process, and then re-injected into the ground. Similarly tar sands are leached of their petroleum with steam, and the resulting waste includes huge amounts of polluted water, stored in ponds.

Agriculture is the largest user of fresh water, which makes it a very attractive area of invention for reduced water consumption.

Plants transpire water, and between 95% and 99% of water absorbed by the plant is released into the atmosphere through transpiration. That is, plants retain less than 5% of the water they adsorb.

There is a large need to purify water without using large amounts of energy. Water recovery methods which use large amounts of energy make water production very expensive; an example of this is typified by Reverse Osmosis, which uses considerable amounts of energy, due to the high pressures required. Our invention is economical of energy, and, in produces water at a cost which is suitable for agricultural use, as well as for producing potable water.

### SUMMARY OF THE INVENTION

Our invention is a new process for reclaiming dirty water, and for minimizing water loss. Using plastic or glass to make “super-greenhouses” and the idea to use the enclosure(s) to control water loss and recycle the evaporated and transpired water came from considering greenhouses and their normal uses in horticulture. We concluded that normal greenhouses have the following functions:
Retain the heat provided by the Sun to facilitate plant growth
Provide an environment that facilitates control of insects and other pests

As a result of investigating various styles of greenhouses, we concluded that greenhouses could also be useful for containing and recovering moisture normally lost to evaporation and transpiration. Transpiration water loss can be over 80% of the water used by plants, so transpiration water recovery results in very large savings in both water and water reclamation costs.

The process for maximizing horticultural output, and/or low-cost potable water, from a quantity of polluted water, is divided into the following sections:
Possible Water sources (incomplete, as these are examples, not an exhaustive list)
Waste water reuse
Condensation Greenhouses
Cost comparison with Reverse Osmosis Purification

We should note here that our method is not limited to producing agricultural water. The horticultural (or agricultural) quality water can be further refined to produce potable water for human and animal consumption; our methodology has been prioritized so that we can produce quantities of water fit for agriculture without wasting the energy to turn it into potable water.

### BRIEF DESCRIPTION OF THE DRAWINGS

FIG. 1, a plan view of a “chain” or Greenhouses, starting for the left with an optional lined evaporation pond, or wetland, depending on the pollutants in the water, continuing with a number of greenhouses and associated condensers or dehumidifiers.

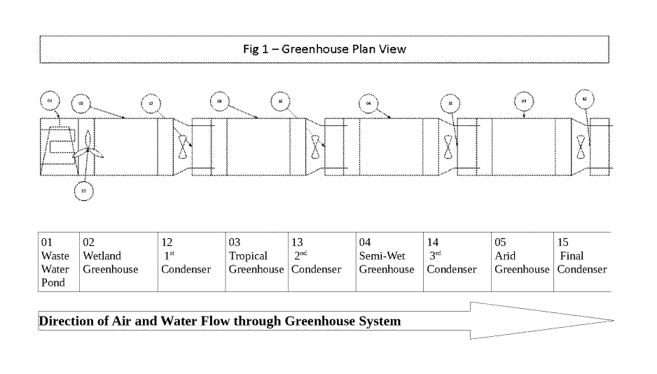

### DETAILED DESCRIPTION OF THE INVENTION

Ambient air enters the Greenhouse system though an optional section of greenhouse 01 which contains a lined evaporation pond or wetland (evaporation for petroleum or chemical pollutants, wetland for animal pollutants) with agitated water to increase the surface area of water exposed to the air.

The water in the lined pond may be contaminated by a variety of pollutants from e-coli through fracking waste.

Water is purified by evaporation, and the movement of air through the greenhouse is controlled by a variable speed fan 22 to saturate the ambient air to as close to the dew point as is feasible.

The ambient air passes through a greenhouse 02 that is growing horticultural crops, for example fruit or vegetables, and further moisture is released into the air through the transpiration of the plants growing in the greenhouse.

At the exit to this first greenhouse is a dehumidifier/condenser 12 which condenses the moisture in the air to be split between the first Greenhouse 02 and the second Greenhouse 03 to provide water for the crops in Greenhouses 02 and 03.

The rationale behind recovering this water for irrigation is that, of the water plants absorb, 95% to 99% is released through transpiration, and the plants only consume (hold in their tissues) 1% to 5% of water adsorbed.

Similarly, the dehumidifier/condenser 13 at the exit of Greenhouse 03 recaptures the water transpired from plant in green house 03, for use in Greenhouses 03 and 04.

Each successive greenhouse-dehumidifier/condenser pair act in a similar manner, until the water available to be condensed in the final greenhouse is only just sufficient for plant growth in the final greenhouse, used by plants from arid climates.

Depending of the length of the greenhouse chain, which is in turn governed by the size of the field containing the greenhouses, the process of gravitational filtering in a lined settling pond, followed by transpiration and dehumidifying/condensation can be repeated as desired. The more land available, the more repetitions of the basic pattern can be produced.

The system employs a control system which manages temperature and humidity by using gauges and sensors in each green house, and which adjusts the rate of air flow to provide maximum water production for the chain of the greenhouses.

Our invention is a process for the economical recovery of polluted water, and for producing water suitable for uses specified by the user. Our process can produce agricultural water (with residual dissolved nitrates), suitable for growing crops and reducing fertilizer costs; by adding additional refining stages, potable water can be produced. We believe our process is optimally suited for agricultural use, and optionally may be used for producing water for animal and human use.

The process is particularly suitable for arid locations, where there is abundant land, along with a source of non-potable polluted water. We use some of the land to create one or more wetlands, adding a non-porous lining to prevent leaching. Polluted water is pumped into the wetland “pond,” and is allowed to evaporate. The evaporated water is collected and condensed to its liquid form, whence it is available for use by plants or humans. Periodically, the ponds are cleaned, and the residue is removed, possibly be replacing the lining.

Each field would be covered with a number of these serial greenhouses, to keep the transpired water inside the greenhouses, whence it can be recovered and recycled by both natural daily cycles and by the Condensers.

The objective is to use the wetland section to purify the water through plant transpiration, and condense the water transpired from the wetland plants for use in the “tropical” food greenhouse. The tropical plants transpire and send moist air to the semi-wet greenhouse to be used by yet another set of plants, and the cycle of transpiration and water recovery from the air continues until the exit air is below 15% to 25% relative humidity. Note the tropical—subtropical—temperate plant cycle in the greenhouses. As the moisture moves from “tropical” to “subtropical,” there is less moisture, but the temperature remains fairly similar. The move from subtropical to temperate reflects both less transpired water, and the lower temperature at the end of the greenhouse. Every plant group gets the water and the temperature it needs to grow well! This cycle repeats with every greenhouse.

Potable Water
In addition to methods from Phase 1, add recovered condensation from greenhouses as a water source. The condensed water can be used directly by humans and animals.

After the first stage, the wetland, the condensed water is suitable for human use. The water is effectively distilled water, where the energy for distillation is provided by the sun.

1. A process which produces potable water with very low energy costs comprising the steps of: Evaporating from polluted, water from an optional lined evaporation pond and adding to the moisture content of ambient air, then condensing the moisture in the air for human, animal or plant consumption.

2. The process of claim 1, coupled with recovering the water transpired from plants to save pure water from being lost into the atmosphere by condensing that water vapor for human, animal or plant consumption, used repetitively in a chain of one or more greenhouses

3. The process step of claim 1 and/or claim 1 and claim 2 enabling more land to be used for more growing crops

4. The process of claim 1 and claim 2 enabling growing crops or increasing the amount of crops growing arid and semi-arid areas.

5. The process of claims 1, 2 and 3 in conjunction with the use of Solar Energy to provide the motivation energy for condensation.

6. The process of claim 5 and the condensation of water at night, making used of the natural cooing in arid areas which occurs overnight, to increase water production and reduce energy consumption.

7. The process of claim 5 coupled with the use of Solar Energy capture in the day and stored in batteries or capture as cool water of Ice to aid in water condensation.
